(19) United States
(12) Patent Application Publication
(10) Pub. No.: US 2025/0334158 A1
(43) Pub. Date: Oct. 30, 2025

(54) ELECTRIC BRAKE APPARATUS AND DRIVE UNIT

(71) Applicant: Hitachi Astemo, Ltd., Hitachinaka-shi, Ibaraki (JP)

(72) Inventors: Koichi SAKIMOTO, Hitachinaka-shi, Ibaraki (JP); Takayasu SAKASHITA, Hitachinaka-shi, Ibaraki (JP); Rikiya YOSHIZU, Hitachinaka-shi, Ibaraki (JP)

(21) Appl. No.: 18/688,876

(22) PCT Filed: Dec. 5, 2022
(86) PCT No.: PCT/JP2022/044684

§ 371 Date: Aug. 22, 2024

(30) Foreign Application Priority Data
Dec. 20, 2021 (JP) 2021-206048

(51) Int. Cl. F16D 65/18; B60T 13/74; F16D 7/02; F16D 55/226; F16D 121/24; F16D 125/40

(52) U.S. Cl. CPC F16D 65/183; B60T 13/741; F16D 7/022; F16D 55/226; F16D 2121/24; F16D 2125/40

(57) ABSTRACT

A fail-open mechanism employed in a disk brake that is an electric brake apparatus includes a spring clutch disposed between a spindle and a torque transmission member and configured to cause the torque transmission member to rotate together with the spindle until a rotational resistance force between the spindle and the spring clutch exceeds a predetermined value, a non-rotatably configured fixation member, and a torsion spring having a one-end portion connected to the torque transmission member and an opposite-end portion connected to the fixation member and configured to store elastic energy therein due to a rotation of the torque transmission member relative to the fixation member according to the rotation of the spindle. As a result, the disk brake can prevent or reduce the impairment of layout flexibility thereof.

### TECHNICAL FIELD

The present invention relates to an electric brake apparatus and a drive unit.

### BACKGROUND ART

PTL 1 discloses an electric brake apparatus including a spindle driven by an electric motor and a mechanical store (a spiral spring) for storing energy by twisting. The mechanical store has a first end coupled to the spindle and a second end coupled to a bracing element. The mechanical store takes up energy during rotation of the spindle, by which energy the spindle is rotated back in a currentless state of the electric motor, whereby the brake is released.

### CITATION LIST

### Patent Literature

PTL 1: US Patent Application Publication No. 2013/0264153

### SUMMARY OF INVENTION

### Technical Problem

However, the electric brake apparatus discussed in PTL 1 is structured in such a manner that an element called the bracing element with one end of the spiral spring coupled thereto, which is slidably actuated by a torque equal to or greater than a predetermined value to prevent or reduce excessive energy storage, is provided at the end portion of the spindle in the rotational axis direction, thereby raising such a concern that the layout flexibility of the electric brake apparatus is impaired.

Under these circumstances, one of objects of the present invention is to provide an electric brake apparatus and a drive unit capable of preventing or reducing the impairment of the layout flexibility.

### Solution to Problem

As a measure for solving the above-described problem, an electric brake apparatus according to the present invention includes an electric motor, a rotational member configured to rotate based on driving of the electric motor, a linear motion member configured to linearly move in an axial direction of a disk due to the rotation of the rotational member and move a frictional pad, a torque transmission member, a torque limiter mechanism disposed between the rotational member and the torque transmission member and configured to cause the torque transmission member to rotate together with the rotational member until a rotational resistance force between the rotational member and the torque limiter mechanism exceeds a predetermined value, a fixation portion, and an elastic member having a one-end portion connected to the torque transmission member and an opposite-end portion connected to the fixation portion and configured to store elastic energy therein due to a rotation of the torque transmission member relative to the fixation portion according to the rotation of the rotational member.

Further, an electric brake apparatus according to the present invention includes an electric motor, a rotational member coupled with the electric motor, a linear motion member threadedly engaged with the rotational member, a torque transmission member, a torque limiter mechanism disposed between the rotational member and the torque transmission member and configured to cause the torque transmission member to rotate together with the rotational member until a rotational resistance force between the rotational member and the torque limiter mechanism exceeds a predetermined value, a fixation portion, and a torsion spring having a one-end portion connected to the torque transmission member and an opposite-end portion connected to the fixation portion.

Further, a drive unit according to the present invention is configured to provide power for pressing a frictional pad against a disk of a disk brake. The drive unit includes an electric motor, a rotational member configured to rotate based on driving of the electric motor, a linear motion member configured to linearly move due to the rotation of the rotational member, a torque transmission member, a torque limiter mechanism disposed between the rotational member and the torque transmission member and configured to cause the torque transmission member to rotate together with the rotational member until a rotational resistance force between the rotational member and the torque limiter mechanism exceeds a predetermined value, a fixation portion, and an elastic member having a one-end portion connected to the torque transmission member and an opposite-end portion connected to the fixation portion and configured to store elastic energy therein due to a rotation of the torque transmission member relative to the fixation portion according to the rotation of the rotational member.

According to one aspect of the present invention, the impairment of the layout flexibility can be prevented or reduced.

### BRIEF DESCRIPTION OF DRAWINGS

FIG. 1 is a cross-sectional view of main portions of a disk brake according to a first embodiment.

FIG. 2 is an exploded perspective view of a rotation-linear motion conversion mechanism and a fail-open mechanism including a piston, which are employed in the disk brake according to the first embodiment.

FIG. 3 is an exploded perspective view of the fail-open mechanism employed in the disk brake according to the first embodiment.

FIG. 4 is a plan view illustrating the disk brake according to the first embodiment with a spring clutch mounted on a spindle and a torque transmission member not yet attached thereto.

FIG. 5 is a plan view illustrating the disk brake according to the first embodiment with the spring clutch mounted on the spindle and the torque transmission member attached thereto.

FIG. 6 is a cross-sectional view illustrating the disk brake according to the first embodiment with a retaining ring and the spring clutch mounted between the spindle and the torque transmission member.

FIGS. 7(a) and 7(b) are cross-sectional views of the disk brake according to the first embodiment, illustrating the function of the spring clutch in a step-wise manner.

FIGS. 8(a) and 8(b) are schematic views of the disk brake according to the first embodiment, illustrating the function of the fail-open mechanism in a step-wise manner.

FIG. 9 is an exploded perspective view of a rotation-linear motion conversion mechanism and a fail-open mechanism including a piston, which are employed in a disk brake according to a second embodiment.

FIG. 10 is a cross-sectional view illustrating the disk brake according to the second embodiment with a truncated conical spring provided between the spindle and the torque transmission member.

FIG. 11 is a schematic view of main portions of a disk brake according to a third embodiment.

### DESCRIPTION OF EMBODIMENTS

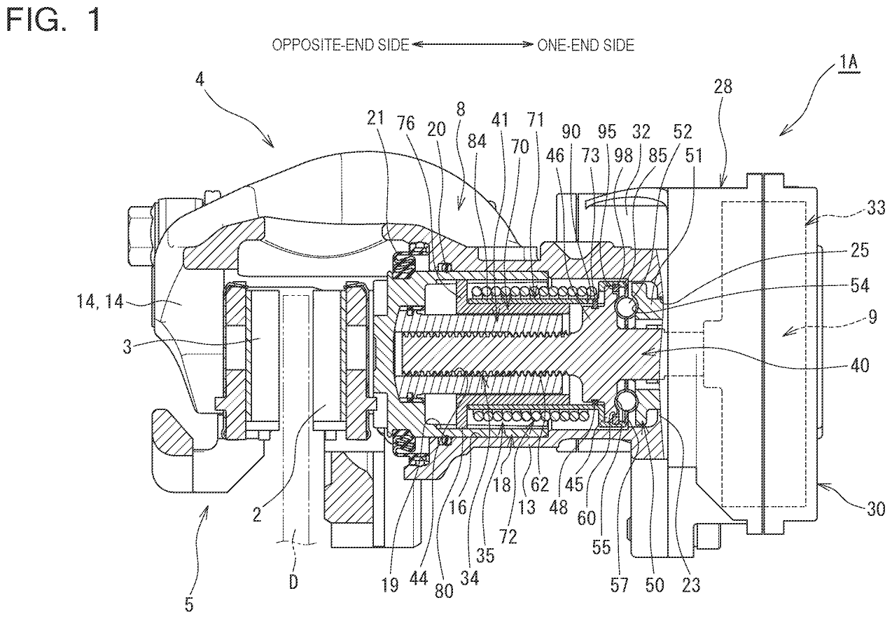

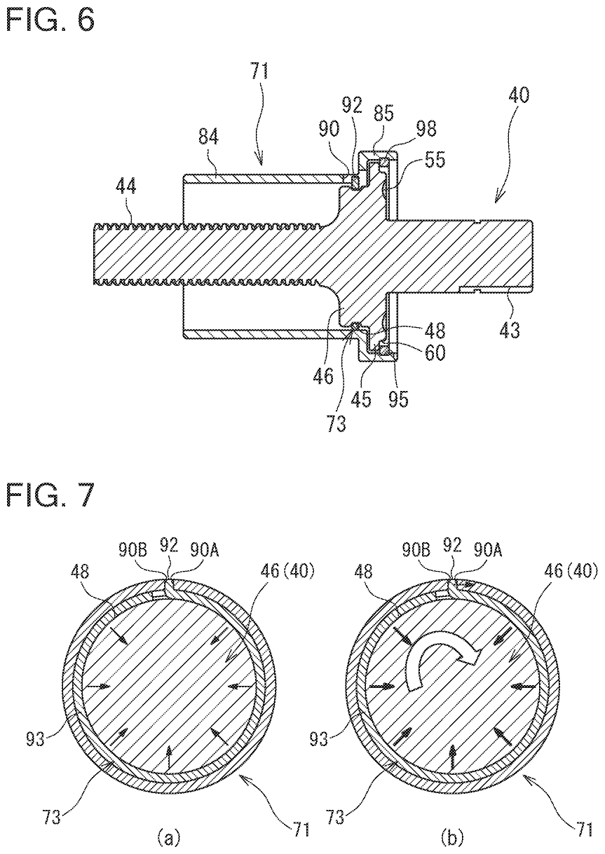

In the following description, embodiments of the present invention will be described in detail with reference to FIGS. 1 to 11.

Disk brakes 1A, 1B, and 1C according to first to third embodiments of the present invention are each an electric brake apparatus that generates a braking force by driving an electric motor 32 while a vehicle runs normally. In the following description, the present embodiments will be described, referring to the internal side of the vehicle (the inner side) as a one-end side (a cover member 30 side), and the external side of the vehicle (the outer side) as an opposite-end side (a disk rotor D side) as necessary.

First, the disk brake 1A according to the first embodiment will be described with reference to FIGS. 1 to 8.

Referring to FIG. 1, the disk brake 1A according to the first embodiment includes a pair of inner and outer brake pads 2 and 3 and a caliper 4. The pair of inner and outer brake pads 2 and 3 is disposed on both the axial sides of the disk rotor D mounted at a rotational portion of the vehicle. The present disk brake 1A is configured as a floating caliper-type disk brake. The pair of inner and out brake pads 2 and 3, and the caliper 4 are supported on a carrier 5 movably in the axial direction of the disk rotor D. The carrier 5 is fixed to a non-rotational portion such as a knuckle of the vehicle. The inner brake pad 2 and the outer brake pad 3 correspond to a frictional pad. The disk rotor D corresponds to a disk.

Referring to FIG. 1, the caliper 4 includes a caliper main body 8 and a drive unit 9. The caliper main body 8 constitutes the main body of the caliper 4. The drive unit 9 provides power to press the inner brake pad 2 and the outer brake pad 3 against the disk rotor D. The caliper main body 8 includes a cylindrical cylinder portion 13 and a pair of claw portions 14 and 14. The cylinder portion 13 is disposed on the proximal end side facing the inner brake pad 2, and is opened, facing this inner brake pad 2. The pair of claw portions 14 and 14 extends from the cylinder portion 13 to the outer side across over the disk rotor D, and is disposed on the distal end side (the opposite-end side) facing the outer brake pad 3. FIG. 1 illustrates only one of the pair of claw portions 14 and 14.

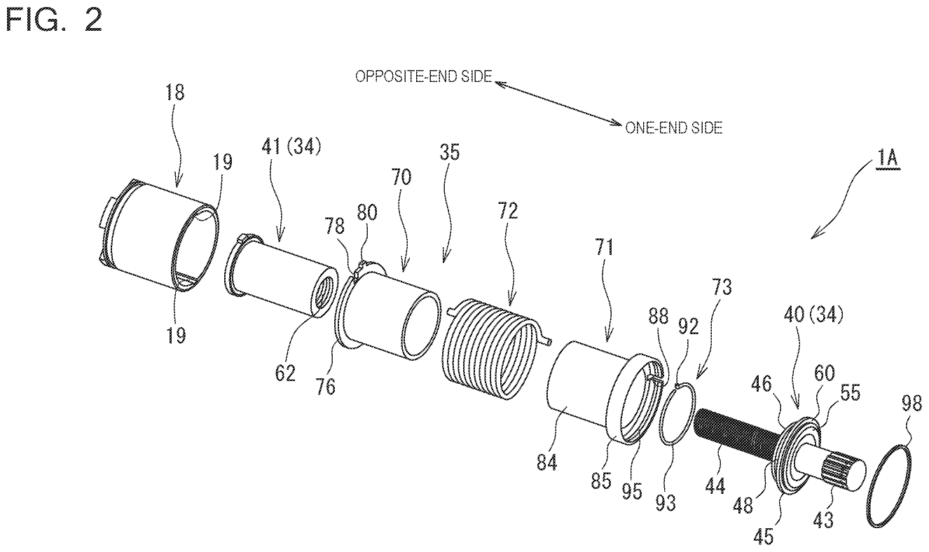

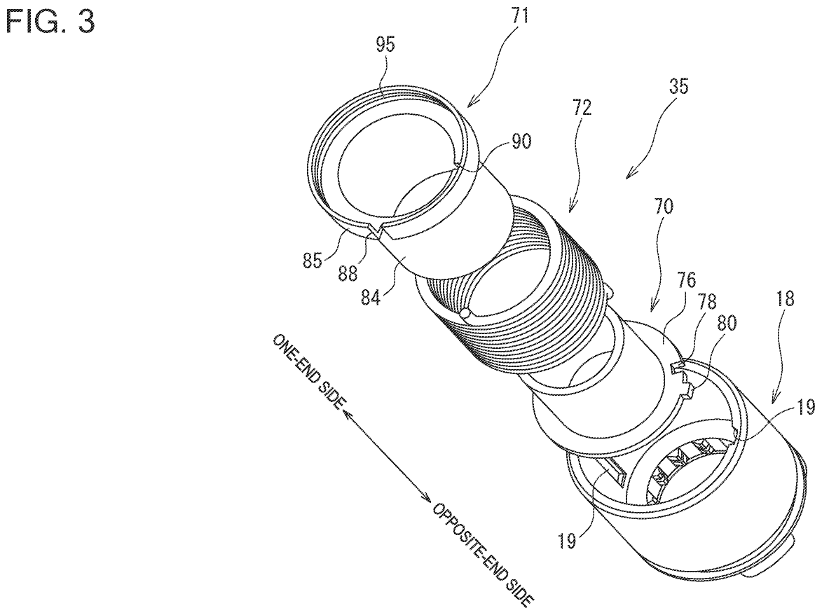

Referring to FIGS. 1 and 2, a piston 18 is contained non-rotatably and axially movably relative to the cylinder portion 13 inside the cylinder portion 13 of the caliper main body 8, i.e., in a cylinder bore 16 of the cylinder portion 13. The piston 18 functions to press the inner brake pad 2, and is formed into a bottomed cupped shape. This piston 18 is contained in the cylinder bore 16 in such a manner that the bottom portion thereof faces the inner brake pad 2. The piston 18 is supported non-rotatably relative to the cylinder bore 16 of the cylinder portion 13 and thus the caliper main body 8 due to engagement prohibiting a rotation between the bottom portion of the piston 18 and the inner brake pad 2, such as recess-protrusion engagement. Referring to FIGS. 2 and 3, a plurality of axially extending vertical engagement groove portions 19 is formed on the inner peripheral surface of the piston 18 along the circumferential direction. In the present embodiment, the vertical engagement groove portions 19 are formed at two portions at a pitch of 180°.

Referring to FIG. 1, a seal member 20 is disposed in the cylinder bore 16 of the cylinder portion 13 on the inner peripheral surface on the opposite-end side thereof. Then, the piston 18 is contained in the cylinder bore 16 axially movably in a state in contact with this seal member 20. A dust boot 21 is interposed between the outer wall portion of the piston 18 on the bottom portion side thereof and the inner peripheral surface of the cylinder bore 16 on the opposite-end side thereof having an increased diameter. The electric brake apparatus 1A is configured to prevent an entry of a foreign object into the cylinder bore 16 of the cylinder portion 13 with the aid of these seal member 20 and dust boot 21.

A gear housing 28 is integrally coupled with a bottom wall 23 side (the one-end side) of the cylinder portion 13. An insertion hole 25 is provided on the bottom wall 23 of the cylinder portion 13, and a spindle 40, which will be described below, extends into the gear housing 28 via this insertion hole 25. An opening of the housing 28 on the one-end side thereof is air-tightly closed by the cover member 30. The drive unit 9 is disposed in the gear housing 28 and the cylinder bore 16 of the cylinder portion 13. The drive unit 9 is provided to transmit a rotation input from the electric motor 32 to the piston 18 contained in the cylinder bore 16 of the cylinder portion 13 and press the inner brake pad 2 and the outer brake pad 3 against the disk rotor D using the thrust force of this piston 18.

Referring to FIG. 1, the drive unit 9 includes the electric motor 32, a speed reduction gear mechanism 33, a rotation-linear motion conversion mechanism 34, and a fail-open mechanism 35. The rotation from the electric motor 32 is transmitted to the speed reduction gear mechanism 33, and the speed reduction gear mechanism 33 powers up the rotational torque input from this electric motor 32. The rotation-linear motion conversion mechanism 34 converts the rotation input from this speed reduction gear mechanism 33 into a linear motion and applies the thrust force to the piston 18. When the electric motor 32 cannot be driven normally due to a failure in a power source or the like during braking, the fail-open mechanism 35 releases this braking force. The driving of the electric motor 32 is controlled according to an instruction from a control device (not illustrated).

This control device functions to control the rotation of the electric motor 32 (the rotational direction, the rotational speed, and the like) based on various detection signals, such as detection signals from a detection sensor (not illustrated) that responds to a request from a driver and a detection sensor (not illustrated) that detects various situations requiring the brake, a detection signal from a wheel speed detection sensor (not illustrated) that detects a wheel speed, a detection signal from the rotational angle detection unit (not illustrated) that detects a rotational angle of the electric motor 32, and a detection signal from a thrust force sensor (not illustrated) or the like that detects the thrust force (the pressing force) applied from the inner and outer brake pads 2 and 3 to the disk rotor D at the time of braking while the vehicle runs normally.

The electric motor 32 and the speed reduction gear mechanism 33 are contained in the gear housing 28. The speed reduction gear mechanism 33 functions to power up the rotational torque input from the electric motor 32 and transmit it to the rotation-linear motion conversion mechanism 34. For example, a planetary gear mechanism is employed as the speed reduction gear mechanism 33. The rotation-linear motion conversion mechanism 34 and the fail-open mechanism 35 are contained in the cylinder bore 16 of the cylinder portion 13. The rotation-linear motion conversion mechanism 34 includes the spindle 40 and a nut member 41. The rotation from the speed reduction gear mechanism 33 is transmitted to the spindle 40. The nut member 41 is threadedly engaged with this spindle 40.

In the disk brake 1A according to the first embodiment, the spindle 40 corresponds to a rotational member, and the nut member 41 corresponds to a linear motion member. Referring to FIGS. 1 and 2, the spindle 40 includes a spline shaft portion 43, an externally threaded portion 44, an annular support portion 45, and a columnar support portion 46. The spline shaft portion 43 is provided on the one-end side of the spindle 40. The externally threaded portion 44 is provided on the opposite-end side of the spindle 40. The annular support portion 45 is provided in a manner protruding radially from the outer peripheral surface of the one-end side with respect to this externally threaded portion 44. The columnar support portion 46 is provided between the annular support portion 45 and the externally threaded portion 44.

Referring to FIGS. 1 and 2, the spline shaft portion 43 of the spindle 40 is connected non-rotatably relative to an output member (not illustrated) of the speed reduction gear mechanism 33 in the gear housing 28. As a result, the rotational torque can be mutually transmitted between the output member of the speed reduction gear mechanism 33 and the spindle 40. Referring to FIG. 1, a thrust bearing 50 is disposed between the annular support portion 45 of the spindle 40 and the bottom wall 23 of the cylinder portion 13. The spindle 40 is rotatably supported on the bottom wall 23 of the cylinder portion 13 with the aid of this thrust bearing 50. The thrust bearing 50 includes a cylindrical thrust member 51 and a plurality of thrust balls 52. The thrust member 51 is disposed on the bottom wall 23 side of the cylinder portion 13. The thrust balls 52 are rollably disposed between this thrust member 51 and the annular support portion 45 of the spindle 40.

A rolling groove 54 is formed on the opposite-end surface of the thrust member 51.

Each of the thrust balls 52 rolls in the rolling groove 54. A rolling groove 55 is formed on the one-end surface of the annular support portion 45 of the spindle 40. Each of the thrust balls 52 rolls in the rolling groove 55. Then, the plurality of thrust balls 52 is rollably disposed between the rolling groove 54 of the thrust member 51 and the rolling groove 55 provided on the annular support portion 45 of the spindle 40. This plurality of thrust balls 52 is held at predetermined circumferential intervals by a retainer 57. The spindle 40 is inserted through in the thrust member 51 of the thrust bearing 50. Referring to FIGS. 1 and 2, a cutout stepped portion 60 is formed on one end of the annular support portion 45 of the spindle 40. The cutout stepped portion 60 is formed by radially and axially cutting out the outer peripheral edge of this one end. A retaining ring 98 is disposed in this cutout stepped portion 60.

Referring to FIGS. 1 and 2, the columnar support portion 46 is provided on the spindle 40 between the annular support portion 45 and the externally threaded portion 44. The outer diameter of this columnar support portion 46 is larger than the outer diameter of the externally threaded portion 44, and is smaller than the annular support portion 45. The outer diameter of the columnar support portion 46 is approximately equal to the diameter of the outer peripheral surface of a fixation member 70, which will be described below. An annular groove portion 48 is formed on the outer peripheral surface of the columnar support portion 46. A spring clutch 73, which will be described below, is disposed in this annular groove portion 48.

Referring to FIGS. 1 and 2, the nut member 41 is disposed on the radially outer side with respect to the externally threaded portion 44 of the spindle 40. The nut member 41 is formed into a cylindrical shape elongated along the axial direction. An internally threaded portion 62 is formed on the inner peripheral surface of the one-end side of the nut member 41. Then, the externally threaded portion 44 of the spindle 40 and the internally threaded portion 62 of the nut member 41 are threadedly engaged with each other. The nut member 41 is supported non-rotatably relative to the piston 18 and thus the cylinder portion 13. This makes the nut member 41 movable along the axial direction according to the rotation of the spindle 40.

Referring to FIG. 1, the fail-open mechanism 35 is provided on the radially outer side with respect to the nut member 41 in the cylinder bore 16. The fail-open mechanism 35 can release a braking force quickly at the time of, for example, a failure in the power source or the like. Also referring to FIGS. 2 and 3, the fail-open mechanism 35 includes the fixation member 70, the torque transmission member 71, a torsion spring 72, and the spring clutch 73. The fixation member 70 is generally formed into a cylindrical shape. The nut member 41 is inserted through in the fixation member 70.

Referring to FIGS. 1 to 3, an annular protrusion portion 76 is provided at the opposite end of the fixation member 70. The annular protrusion portion 76 is provided in a manner protruding radially outward and annularly. A spring containing recessed portion 78 is formed on the outer peripheral surface of this annular protrusion portion 76 at a predetermined position along the circumferential direction of this outer peripheral surface. The opposite end of the torsion spring 72 is contained in this spring containing recessed portion 78. Engagement protrusion pieces 80 are formed on the outer peripheral surface of the annular protrusion portion 76. The engagement protrusion pieces 80 protrude radially outward. The engagement protrusion pieces 80 are formed at two portions at a pitch of 180° so as to correspond to the vertical engagement groove portions 19 provided on the piston 18, respectively, in the present embodiment. Then, the fixation member 70 is inserted in the piston 18, and the engagement protrusion pieces 80 of the fixation member 70 are engaged with the vertical engagement groove portions 19 provided on the piston 18, respectively. As a result, the fixation member 70 is supported non-rotatably relative to the piston 18 and thus the cylinder portion 13. In the disk brake 1A according to the first embodiment, the fixation member 70 corresponds to a fixation portion.

Referring to FIG. 1, the torque transmission member 71 is disposed so as to cover the one-end side of the fixation member 70 with respect to the annular protrusion portion 76 and the annular support portion 45 of the spindle 40 from the radial direction. Also referring to FIGS. 2 and 3, the torque transmission member 71 is generally formed into a cylindrical shape. The torque transmission member 71 includes a small-diameter cylindrical portion 84 and a large-diameter cylindrical portion 85. The small-diameter cylindrical portion 84 constitutes the main body of the torque transmission member 71. The large-diameter cylindrical portion 85 is provided continuously from one end of the small-diameter cylindrical portion 84 to the one-end side. The small-diameter cylindrical portion 84 extends from the annular protrusion portion 76 of the fixation member 70 toward the one-end side to reach the axially entire region of the columnar support portion 46 of the spindle 40. As a result, the fixation member 70 and the small-diameter cylindrical portion 84 of the torque transmission member 71 are disposed so as to overlap each other as viewed from the radial direction. Further, the large-diameter cylindrical portion 85 covers the annular support portion 45 of the spindle 40 from the radial direction, and slightly protrudes from the one-end surface of the annular support portion 45 to the one-end side. As a result, the annular support portion 45 of the spindle 40 and the large-diameter cylindrical portion 85 of the torque transmission member 71 are disposed so as to overlap each other as viewed from the radial direction. Then, the torque transmission member 71 is rotatably supported around the fixation member 70 and the annular support portion 45 of the spindle 40.

Referring to FIGS. 2 and 3, the circumferential wall portion of the large-diameter cylindrical portion 85 includes a spring containing cutout portion 88 formed so as to radially extend therethrough at a predetermined position along the circumferential direction thereof. This spring containing cutout portion 88 is formed throughout the entire axial range of the large-diameter cylindrical portion 85. One end of the torsion spring 72 is contained in this spring containing cutout portion 88. Referring to FIGS. 1 and 4 to 6, an engagement slit portion 90 is formed at the boundary between the large-diameter cylindrical portion 85 and the small-diameter cylindrical portion 84 and a predetermined position along the circumferential direction thereof, so as to radially extend therethrough. The engagement slit portion 90 slightly extends toward the small-diameter cylindrical portion 84 along the axial direction. A distal end portion 92 of the spring clutch 73, which will be described below, is engaged with this engagement slit portion 90. In the disk brake 1A according to the first embodiment, this engagement slit portion 90 corresponds to a fitted portion.

Referring to FIG. 1, the torsion spring 72 is disposed along the outer peripheral surface of the small-diameter cylindrical portion 84 of the torque transmission member 71. In other words, the small-diameter cylindrical portion 84 of the torque transmission member 71 and the torsion spring 72 are disposed so as to overlap each other as viewed from the radial direction. In the disk brake 1A according to the first embodiment, the torsion spring 72 corresponds to an elastic member. Referring to FIGS. 2 and 3, one end of the torsion spring 72 is bent so as to extend axially. The opposite end of the torsion spring 72 is also bent so as to extend axially. Referring to FIGS. 2 and 3, both the ends of the torsion spring 72 are placed at positions different along the circumferential direction, respectively. For example, in the disk brake 1A according to the first embodiment, both the axial ends of the torsion spring 72 are placed at positions different by approximately 45° along the circumferential direction, respectively.

Then, the torsion spring 72 is disposed along the outer peripheral surface of the small-diameter cylindrical portion 84 of the torque transmission member 71 as described above. Referring to FIGS. 2 and 3, the one end of the torsion spring 72 is contained in the spring containing cutout portion 88 provided on the large-diameter cylindrical portion 85 of the torque transmission member 71. On the other hand, the opposite end of the torsion spring 72 is contained in the spring containing recessed portion 78 provided on the annular protrusion portion 76 of the fixation member 70. Due to that, the fixation member 70 and the torque transmission member 71 are coupled via the torsion spring 72.

Referring to FIGS. 1 and 4 to 6, the spring clutch 73 is disposed between the annular groove portion 48 provided on the outer peripheral surface of the columnar support potion 46 of the spindle 40 and the small-diameter cylindrical portion 84 of the torque transmission member 71. In the disk brake 1A according to the first embodiment, the spring clutch 73 corresponds to a torque limiter mechanism. The spring clutch 73 functions as a one-way torque limiter that provides rotational resistance only against a rotation of the spindle 40 in one direction (a rotation in a braking direction in the present embodiment). Also referring to FIG. 2, the spring clutch 73 is constructed by curving a rod-like member circular in cross-section into a C-like shape in a planar view. The spring clutch 73 includes the distal end portion 92 and a coil portion 93. The distal end portion 92 extends radially outward. The coil portion 93 is single-wound into a circular-arc shape continuously from this distal end portion 92.

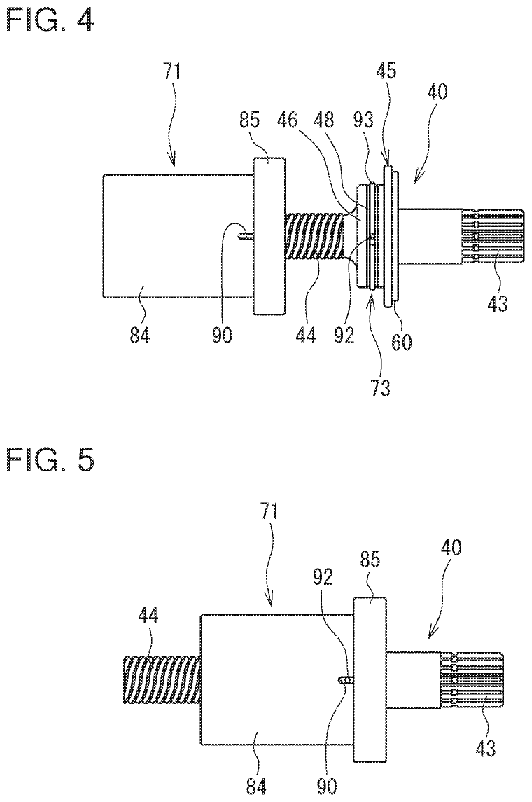

Then, referring to FIGS. 4 to 6, the coil portion 93 of the spring clutch 73 is wound around the annular groove portion 48 provided on the outer peripheral surface of the columnar support portion 46 of the spindle 40. The distal end portion 92 of the spring clutch 73 is engaged with the engagement slit portion 90 provided on the torque transmission member 71. Referring to FIG. 1, the spring clutch 73 and the torsion spring 72 are disposed so as to overlap each other as viewed from the radial direction. This spring clutch 73 is configured to permit a rotation of the spindle 40 in a rotational direction at the time of braking release while providing rotational resistance against a rotation of the spindle 40 in a rotational direction at the time of braking.

Referring to FIGS. 4 to 7, the coil portion 93 of the spring clutch 73 is wound around the annular groove portion 48 provided on the outer peripheral surface of the columnar support portion 46 of the spindle 40 in a state of having a predetermined tightening force (a predetermined set load) when the spring clutch 73 is mounted (refer to black filled arrows in FIG. 7(a)). Further, a maximum rotational resistance force exerted by the spring clutch 73 when the spindle 40 rotates in the braking direction (a maximum tightening force directed from the spring clutch 73 to the radial center of the columnar support portion 46 of the spindle 40) is set to be approximately equal to the spring force when the torsion spring 72 is elastically deformed by a predetermined amount in a torsion direction. In other words, when the spindle 40 rotates along the braking direction, the rotation of the spindle 40 is transmitted to the torque transmission member 71 via the spring clutch 73 until the rotational resistance force between the annular groove portion 48 of the columnar support portion 46 of the spindle 40 and the coil portion 93 of the spring clutch 73 (the tightening force directed from the spring clutch 73 to the radial center of the columnar support portion 46 of the spindle 40) exceeds the predetermined elastic deformation amount (a predetermined spring force) of the torsion spring 72 in the torsion direction.

Further, referring to FIGS. 1, 2, and 6, an annular groove portion 95 is formed on the inner peripheral surface of the large-diameter cylindrical portion 85 of the torque transmission member 71. Then, the retaining ring 98 is formed between the cutout stepped portion 60 provided on the one end of the annular support portion 45 of the spindle 40 and the annular groove portion 95 provided on the inner peripheral surface of the large-diameter cylindrical portion 85 of the torque transmission member 71. As a result, an axial movement of the spindle 40 relative to the torque transmission member 71 is restricted. In this manner, referring to FIG. 1, the spindle 40, the nut member 41, the fixation member 70, the torque transmission member 71, the torsion spring 72, and the piston 18 are arranged in the cylinder bore 16 of the cylinder portion 13 in this order starting from the radially inner side toward the radially outer side. In other words, these spindle 40, nut member 41, fixation member 70, torque transmission member 71, torsion spring 72, and piston 18 are disposed so as to overlap one another as viewed from the radial direction.

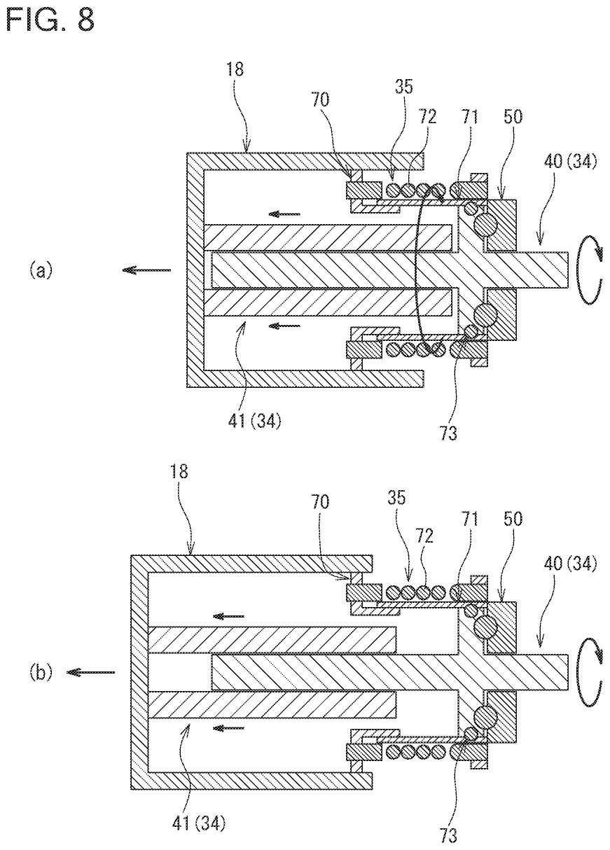

Next, a braking function and a braking release function while the vehicle runs normally, which are exerted in the disk brake 1A according to the first embodiment, will be described referring to FIGS. 7 and 8 and also referring to FIG. 1 as necessary.

At the time of braking while the vehicle runs normally, the drive unit 9 is actuated in reaction to an instruction from the control device. More specifically, the electric motor 32 is driven, and the rotation thereof in the braking direction is transmitted to the spindle 40 via the speed reduction gear mechanism 33. Subsequently, when the spindle 40 rotates according to the rotation of the speed reduction gear mechanism 33, the nut member 41 threadedly engaged with the spindle 40 advances and moves the piston 18 forward from the state illustrated in FIG. 8(a) as illustrated in FIG. 8(b). Due to the advancement of this piston 18, the inner brake pad 2 is pressed against the disk rotor D.

Then, due to a reaction force to the pressing force applied from the piston 18 to the inner brake pad 2, the caliper main body 8 moves to the inner side with respect to the carrier 5, and presses the outer brake pad 3 against the disk rotor D via each of the claw portions 14 and 14. As a result, a frictional force is generated with the disk rotor D sandwiched between the pair of inner and outer brake pads 2 and 3, and this eventually leads to generation of a braking force on the vehicle.

At the time of this braking, referring to FIGS. 7(b) and 8(a), when the spindle 40 rotates in the braking direction (refer to a white outlined arrow in FIG. 7(b) and a black filled arrow in FIG. 8(a)), the tightening force exerted by the spring clutch 73 and directed toward the radial center of the spindle 40 (the rotational resistance force between the annular groove portion 48 of the columnar support portion 46 of the spindle 40 and the spring clutch 73) gradually increases (refer to black filled arrows in FIG. 7(b)) with the distal end portion 92 of the spring clutch 73 kept in abutment with a facing wall surface 90A, which is one of wall surfaces of the engagement slit portion 90 of the torque transmission member 71 that face each other along the circumferential direction, from the state illustrated in FIG. 7(a) as illustrated in FIG. 7(b), and this causes the torque transmission member 71 to rotate in the braking direction via the spring clutch 73 according to the rotation of the spindle 40 referring to FIGS. 8(a) and 8(b). Then, due to the rotation of the torque transmission member 71 in the braking direction relative to the non-rotatably supported fixation member 70, the torsion spring 72 disposed between the torque transmission member 71 and the fixation member 70 is elastically deformed in the torsion direction and stores elastic energy therein.

Subsequently, referring to FIG. 8(b), when the spindle 40 rotates in the braking direction and the spring force (a restoring force) stored on the torsion spring 72 reaches a predetermined amount, i.e., the torsion spring 72 reaches the predetermined elastic deformation amount along the torsion direction, this spring force exceeds the rotational resistance force generated between the annular groove portion 48 of the spindle 40 and the spring clutch 73, and sliding occurs between the annular groove portion 48 of the spindle 40 and the spring clutch 73. As a result, the torque transmission member 71 is prohibited from rotating in the braking direction, and the spring force stored on the torsion spring 72 is kept no more than the predetermined amount.

After that, when the stored spring force of the torsion spring 72 reduces even slightly, the rotational resistance force generated between the annular groove portion 48 of the spindle 40 and the spring clutch 73 exceeds the spring force of the torsion spring 72 again, which causes the rotation of the spindle 40 to be transmitted to the torque transmission member 71 via the spring clutch 73 again and thus the torsion spring 72 to be elastically deformed in the torsion direction again to restore the spring force to the predetermined amount. This operation is repeated. Then, this operation leads to a transition of the spring force stored on the torsion spring 72 by a desired approximately constant amount.

On the other hand, at the time of braking release, the drive unit 9 is actuated in reaction to an instruction from the control device. More specifically, the electric motor 32 rotates in the braking release direction, and, along therewith, this rotation in the braking release direction is transmitted to the spindle 40 via the speed reduction gear mechanism 33. As a result, the nut member 41 threadedly engaged with the spindle 40 and the piston 18 are retracted in an initial position direction (to the one-end side) according to the rotation of the spindle 40 in the braking release direction, by which a predetermined clearance is generated between the inner and outer brake pads 2 and 3 and the disk rotor D, and the braking force is released.

At the time of this braking release, when the spindle 40 rotates in the braking release direction, the tightening force of the spring clutch 73 to the spindle 40 reduces with the distal end portion 92 of the spring clutch 73 kept in abutment with a facing wall surface 90B (refer to FIGS. 7(a) and 7(b)), which is the other of the wall surfaces of the engagement slit portion 90 of the torque transmission member 71 that face each other along the circumferential direction. As a result, the rotation of the spindle 40 in the braking release direction is not transmitted to the torque transmission member 71 via the spring clutch 73, but the torque transmission member 71 rotates in the braking release direction to return in the initial position direction due to the restoring force of the torsion spring 72 elastically deformed at the time of braking.

Further, if a failure occurs in the power source or the like and no rotational torque is generated from the electric motor 32 during braking, the fail-open mechanism 35 of the drive unit 9 is actuated. In other words, if the electric motor 32 is not driven normally during braking, the torsion spring 72 elastically deformed at the time of the braking is restored, i.e., the elastic energy stored at the time of the braking is released. Then, the torque transmission member 71 rotates in the braking release direction due to the restoring force of the torsion spring 72. Then, because the tightening force exerted by the spring clutch 73 and directed toward the radial center of the spindle 40 is in a strong state, the spindle 40 rotates in the braking release direction to return to around the initial position according to the rotation of the torque transmission member 71 in the braking release direction (the return thereof to the initial position). As a result, the nut member 41 and the piston 18 are retracted in the initial position direction, and the braking force applied by the pair of inner and outer brake pads 2 and 3 to the disk rotor D reduces. After that, the vehicle can be moved to a safe place and parked there.

In the above-described manner, the disk brake 1A according to the first embodiment especially includes the torque transmission member 71 disposed on the radially outer side with respect to the spindle 40 and the spring clutch 73 disposed between the columnar support portion 46 of the spindle 40 and the small-diameter cylindrical portion 84 of the torque transmission member 71. As a result, the disk brake 1A according to the first embodiment can achieve a reduction in the length thereof along the axial direction of the disk rotor D. Due to that, the disk brake 1A according to the first embodiment can attain improved layout flexibility and excellent mountability onto a vehicle.

Further, the disk brake 1A according to the first embodiment employs the spring clutch 73 as the torque limiter mechanism that rotates the torque transmission member 71 together with the spindle 40 until the rotational resistance between the spring clutch 73 and the spindle 40 exceeds the predetermined elastic deformation amount (the predetermined spring force) of the torsion spring 72 in the torsion direction. As a result, the approximately constant amount of spring force can be stored on the torsion spring 72 without becoming excessive or insufficient at the time of braking.

In addition, due to the employment of the spring clutch 73 as the torque limiter mechanism, especially, the rotation of the spindle 40 in the braking release direction is not transmitted to the torque transmission member 71 via the spring clutch 73 and the torque transmission member 71 rotates in the braking release direction under the restoring force of the torsion spring 72, and therefore the torque transmission member 71 is prevented from rotating in the braking release direction beyond the initial position at the time of braking release while the vehicle runs normally. Accordingly, a further stable operation with respect to the fail-open mechanism 35 can be ensured. As a result, the disk brake 1A according to the first embodiment eliminates the necessity of providing a unit for controlling the rotation of the torque transmission member 71 relative to the fixation member 70 (which will be described in detail below) or the like, thereby being able to be simply structured and thus achieve a size reduction.

Further, in the disk brake 1A according to the first embodiment, the spring clutch 73 and the torsion spring 72 are disposed so as to overlap each other as viewed from the radial direction. Further, the spindle 40 and the torsion spring 72 are disposed so as to overlap each other as viewed from the radial direction. As a result, the disk brake 1A can achieve a further reduction in the length thereof along the axial direction of the disk rotor D.

Furthermore, in the disk brake 1A according to the first embodiment, the coil portion 93 of the spring clutch 73 is wound in the state of having the tightening force onto the annular groove portion 48 of the spindle 40 when the spring clutch 73 is mounted. As a result, the responsiveness (a prompt rotation) of the torque transmission member 71 in reaction to the rotation of the spindle 40 can be improved at the time of braking. Then, the responsiveness with respect to the storage of the elastic energy onto the torsion spring 72 according to the rotation of the spindle 40 can be improved, and thus a stable operation with respect to the fail-open mechanism 35 can be ensured.

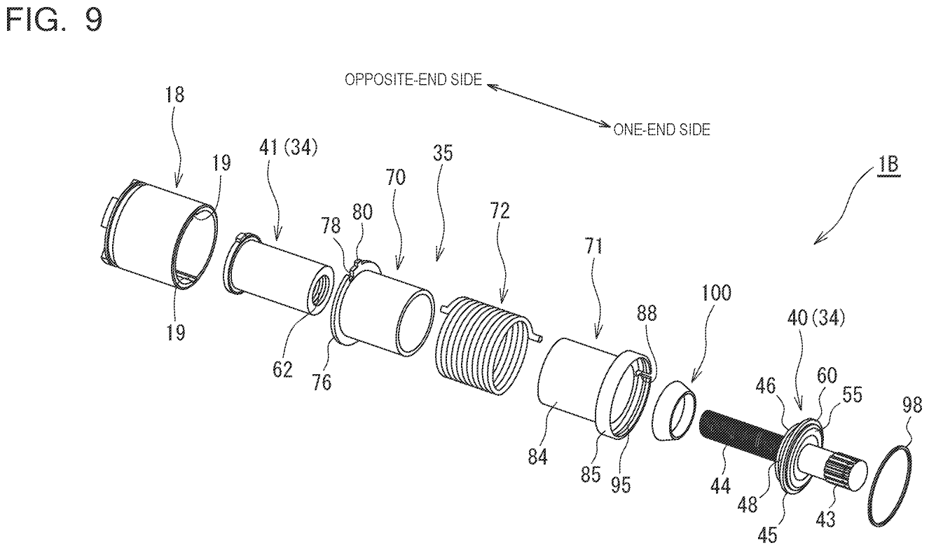

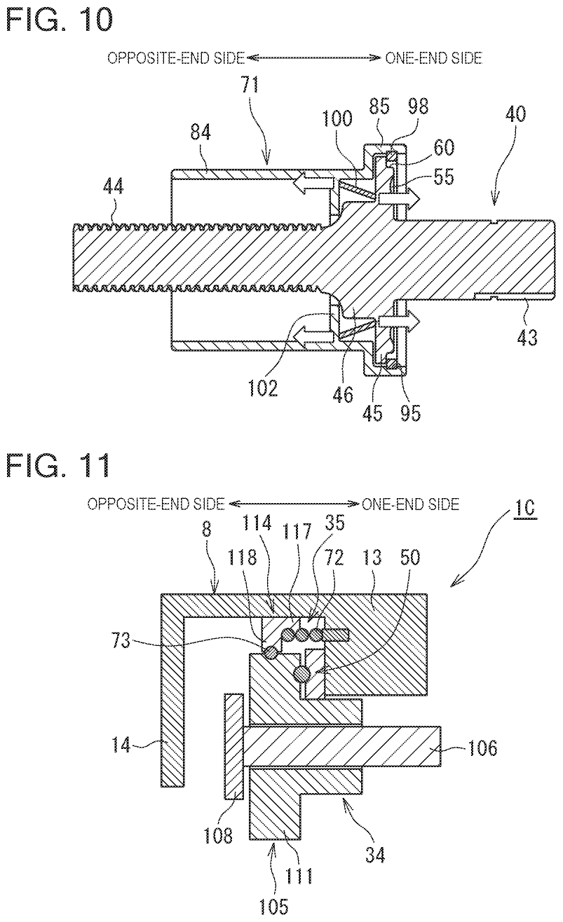

Next, the disk brake 1B according to the second embodiment will be described referring to FIGS. 9 and 10 and also referring to FIG. 1 as necessary. The disk brake 1B according to this second embodiment will be described focusing only on differences from the disk brake 1A according to the first embodiment.

Referring to FIG. 9, the disk brake 1B according to the second embodiment especially employs a truncated conical spring 100 instead of the spring clutch 73 employed in the disk brake 1A according to the first embodiment. This will be more specifically described. Referring to FIG. 10, an inner peripheral flange portion 102 is formed on a position closer to the one end of the small-diameter cylindrical portion 84 of the torque transmission member 71. The inner peripheral flange portion 102 is provided in a radially inward protruding manner. The inner peripheral flange portion 102 is annularly formed. The inner diameter of the inner peripheral flange portion 102 is larger than the outer diameter of the externally threaded portion 44 of the spindle 40, and is smaller than the outer diameter of the columnar support portion 46 of the spindle 40. The one-end surface of the inner peripheral flange portion 102 and the opposite-end surface of the columnar support portion 46 of the spindle 40 are disposed close to each other along the axial direction.

The truncated conical spring 100 is disposed between the inner peripheral flange portion 102 of the torque transmission member 71 and the annular support portion 45 of the spindle 40. The truncated conical spring 100 is cylindrical with a predetermined thickness, and the outer shape thereof is formed into a truncated conical shape. The truncated conical spring 100 is elastically deformed extensibly and compressibly under a compression load along the axial direction. The columnar support portion 46 of the spindle 40 is disposed in the truncated conical spring 100. The large-diameter side of the truncated conical spring 100 is placed at the boundary between the inner peripheral surface of the small-diameter cylindrical portion 84 and the inner peripheral flange portion 102 of the torque transmission member 71. On the other hand, the small-diameter side of the truncated conical spring 100 is placed at the boundary between the annular support portion 45 and the columnar support portion 46 of the spindle 40.

In the disk brake 1B according to the second embodiment, the truncated conical spring 100 corresponds to an elastic body that functions as the torque limiter mechanism. Further, the annular support portion 45 of the spindle 40 corresponds to an outer peripheral flange portion. Further, referring to FIG. 10, the retaining ring 98 is also formed between the cutout stepped portion 60 provided on the one end of the annular support portion 45 of the spindle 40 and the annular groove portion 95 provided on the inner peripheral surface of the large-diameter cylindrical portion 85 of the torque transmission member 71 in the disk brake 1B according to the second embodiment, similarly to the disk brake 1A according to the first embodiment. As a result, an axial movement of the spindle 40 relative to the torque transmission member 71 is restricted.

Referring to FIG. 10, the truncated conical spring 100 is set up between the inner peripheral flange portion 102 of the torque transmission member 71 and the annular support portion 45 of the spindle 40 with the compression load slightly applied thereto when being mounted. In other words, the truncated conical spring 100 is set up in a state of applying a biasing force in a direction for separating the inner peripheral flange portion 102 of the torque transmission member 71 and the annular support portion 45 of the spindle 40 from each other (refer to white outlined arrows in FIG. 10) when being mounted. Then, when the spindle 40 rotates along the braking direction, the rotation of the spring 40 is transmitted to the torque transmission member 71 via the truncated conical spring 100 until the rotational resistance force between the truncated conical spring 100 and the spindle 40/the torque transmission member 71 exceeds the predetermined elastic deformation amount (the predetermined spring force) of the torsion spring 72 in the torsion direction. The spindle 40, the truncated conical spring 100, and the torque transmission member 71 are disposed so as to overlap one another as viewed from the radial direction.

Then, in the disk brake 1B according to the second embodiment, at the time of braking while the vehicle runs normally, the rotation of the spindle 40 in the braking direction causes the torque transmission member 71 to rotate in the braking direction together with the truncated conical spring 100 according to the rotation of the spindle 40 due to the rotational resistance force generated between the truncated conical spring 100 and the spindle 40/the torque transmission member 71. Then, the rotation of the torque transmission member 71 in the braking direction relative to the non-rotatably supported fixation member 70 causes the torsion spring 72 disposed between the torque transmission member 71 and the fixation member 70 to be elastically deformed in the torsion direction and store elastic energy therein.

When the spindle 40 continuously rotates in the braking direction and the torsion spring 72 reaches the predetermined elastic deformation amount along the torsion direction, this spring force exceeds the rotational resistance force generated between the truncated conical spring 100 and the spindle 40/the torque transmission member 71, and sliding occurs between the truncated conical spring 100 and the spring 40/the torque transmission member 71. As a result, the torque transmission member 71 is prohibited from rotating in the braking direction, and the spring force stored on the torsion spring 72 is kept no more than the predetermined amount.

On the other hand, at the time of braking release, when the spindle 40 rotates in the braking release direction, the torque transmission member 71 rotates in the braking release direction together with the truncated conical spring 100 due to the rotational resistance force generated between the truncated conical spring 100 and the spindle 40/the torque transmission member 71, and the restoring force of the torsion spring 72. In sum, the restoring force of the torsion spring 72 is added to assist the spindle 40 rotating in the braking release direction via the torque transmission member 71 and the truncated conical spring 100 as a rotational torque in the braking release direction. Then, according to the rotation of the spindle 40 in the braking release direction, the nut member 41 and the piston 18 are retracted in the initial position direction (to the one-end side), by which the predetermined clearance is generated between the inner and outer brake pads 2 and 3 and the disk rotor D, and the braking force is released.

Further, if a failure occurs in the power source or the like and the electric motor 32 is not driven normally during braking, the torsion spring 72 elastically deformed at the time of the braking is restored, i.e., the elastic energy stored at the time of the braking is released. Then, the torque transmission member 71 rotates in the braking release direction due to the restoring force of the torsion spring 72. Then, because the rotational resistance force generated between the truncated conical spring 100 and the spindle 40/the torque transmission member 71 is in a strong state, the spindle 40 rotates in the braking release direction to return to around the initial position according to the rotation of the torque transmission member 71 in the braking release direction (the return thereof to the initial position). As a result, the nut member 41 and the piston 18 are retracted in the initial position direction, and the braking force applied by the pair of inner and outer brake pads 2 and 3 to the disk rotor D reduces.

The above-described disk brake 1B according to the second embodiment especially also includes the torque transmission member 71 disposed on the radially outer side with respect to the spindle 40 and the truncated conical spring 100 disposed between the annular support portion 45 of the spindle 40 and the inner peripheral flange portion 102 of the torque transmission member 71, similarly to the disk brake 1A according to the first embodiment. As a result, the disk brake 1B can achieve a reduction in the length thereof along the axial direction of the disk rotor D. Further, in the disk brake 1B according to the second embodiment, just the right amount of spring force can also be stored on the torsion spring 72 at the time of braking, and therefore a further stable operation with respect to the fail-open mechanism 35 can be ensured.

Further, in the disk brake 1B according to the second embodiment, the truncated conical spring 100 and the torsion spring 72 are disposed so as to overlap each other as viewed from the radial direction. As a result, the disk brake 1B can achieve a further reduction in the length thereof along the axial direction of the disk rotor D.

Furthermore, in the disk brake 1B according to the second embodiment, the truncated conical spring 100 is set up in the state of applying the biasing force in the direction for separating the inner peripheral flange portion 102 of the torque transmission member 71 and the annular support portion 45 of the spindle 40 from each other when being mounted. As a result, the responsiveness (a prompt rotation) of the torque transmission member 71 in reaction to the rotation of the spindle 40 can be improved at the time of braking. Then, the responsiveness with respect to the storage of the elastic energy onto the torsion spring 72 according to the rotation of the spindle 40 can be improved, and thus a stable operation with respect to the fail-open mechanism 35 can be ensured.

In the disk brake 1B according to the above-described second embodiment, a relative rotation control unit may be provided between the torque transmission member 71 and the fixation member 70. This relative rotation control unit functions to control a circumferential initial relative position of the torque transmission member 71 and the fixation member 70 when they are attached, and a limit relative position for controlling the relative rotational amount of the torque transmission member 71 when the torque transmission member 71 rotates relative to the fixation member 70. In the present embodiment, a set load can be applied to the torsion spring 72 when the torsion spring 72 is mounted, and the return force exerted by the torsion spring 72 can be enhanced. As a result, the braking force applied by the pair of inner and outer brake pads 2 and 3 to the disk rotor D can be further reliably released with the aid of the restoring force of the torsion spring 72 even when a failure occurs in the power source or the like and the electric motor 32 cannot be actuated during braking.

Further, in the present embodiment, since the above-described relative rotation control unit is provided and a set load can be applied to the torsion spring 72 when the torsion spring 72 is mounted, the responsiveness (prompt elastic deformation) of the torsion spring 72 in reaction to the rotation of the torque transmission member 71 can be improved at the time of braking. In sum, the torsion spring 72 can be elastically deformed to store elastic energy therein even during a slight rotation of the torque transmission member 71, and the responsiveness of the torsion spring 72 in reaction to the rotation of the torque transmission member 71 can be improved.

Further, in the present embodiment, due to the provision of the above-described relative rotation control unit, the torsion spring 72 is prevented from returning in the braking release direction beyond the initial torsion angle at the time of, for example, braking release while the vehicle runs normally. In other words, at the time of braking release while the vehicle runs normally, the coil portion can be prevented from bulging due to a twist of the torsion spring 72 in the opposite direction beyond the free state, which might be caused by a rotation of the torque transmission member 71 in the braking release direction beyond the initial position according to the rotation of the spindle 40 in the braking release direction under the rotational resistance generated between the truncated conical spring 100 and the torque transmission member 71/the spindle 40. As a result, a further stable operation can be ensured. This relative rotation control unit is effective for the fail-open mechanism 35 employed in the disk brake 1B according to the second embodiment.

Next, the disk brake 1C according to the third embodiment will be described referring to FIG. 11 and also referring to FIG. 1 as necessary. The disk brake 1C according to this third embodiment will be described focusing only on differences from the disk brake 1A according to the first embodiment. FIG. 11 indicates the cylinder portion 13, a torque transmission member 114, the spring clutch 73, the torsion spring 72, and the thrust bearing 50, illustrating only one side of them based on the radial central axis.

In the disk brake 1C according to the third embodiment, a nut member 105 as the rotation-linear motion conversion mechanism 34 is connected non-rotatably relative to the output member of the speed reduction gear mechanism 33. As a result, the output member of the speed reduction gear mechanism 33 and the nut member 105 transmit a rotational torque mutually therebetween. A push rod 106 is threadedly engaged with the nut member 105. The push rod 106 is supported relatively non-rotatably and movably along the axial direction in the cylinder portion 13. A push plate 108 is connected to the opposite end of the push rod 106. The push plate 108 is used to press the inner brake pad 2. Then, the push rod 106 moves along the axial direction according to the rotation of the nut member 105. In the disk brake 1C according to the third embodiment, the nut member 105 corresponds to the rotational member and the push rod 106 corresponds to the linear motion member.

An annular flange portion 111 is provided at the opposite end of the nut member 105 in a radially outward protruding manner. The thrust bearing 50 is disposed between the one-end surface of the annular flange portion 111 and the cylinder portion 13. The torque transmission member 114 of the fail-open mechanism 35 is disposed on the radially outer side with respect to the annular flange portion 111 of the nut member 105. The torque transmission member 114 is generally formed into a cylindrical shape. The torque transmission member 114 includes a cylindrical portion 117 and an annular flange portion 118. The annular flange portion 118 extends radially inward from the opposite end of the cylindrical portion 117. The torque transmission member 114 and the cylinder portion 13 are coupled via the torsion spring 72. The spring clutch 73 is disposed between the inner peripheral surface of the annular flange portion 118 of the torque transmission member 114 and the outer peripheral surface of the annular flange portion 111 of the nut member 105.

In the disk brake 1C according to the third embodiment, the push rod 106, the nut member 105, the spring clutch 73, and the torque transmission member 114 are disposed so as to overlap one another as viewed from the radial direction. Further, the push rod 106, the nut member 105, the torque transmission member 114, and the torsion spring 72 are disposed so as to overlap one another as viewed from the radial direction. In the disk brake 1C according to the third embodiment, the cylinder portion 13 corresponds to the fixation portion.

Then, in the disk brake 1C according to the third embodiment, at the time of braking while the vehicle runs normally, the electric motor 32 is driven according to an instruction from the control device, and the rotation thereof in the braking direction is transmitted to the nut member 105 via the speed reduction gear mechanism 33. Subsequently, when the nut member 105 rotates according to the rotation of the speed reduction gear mechanism 33, the push rod 106 threadedly engaged with this nut member 105 advances and moves forward the inner brake pad 2 via the push plate 108. Due to the advancement of this push plate 108, the disk rotor D is sandwiched between the inner pad 2 and the outer pad, and a braking force is generated.

At the time of this braking, when the nut member 105 rotates in the braking direction, the torque transmission member 114 rotates in the braking direction together with the spring clutch 73 according to the rotation of the nut member 105 due to a gradual increase in the tightening force exerted by the spring clutch 73 and directed toward the radial center of the nut member 105 (the rotational resistance force between the nut member 105 and the spring clutch 73). Then, due to the rotation of the torque transmission member 114 in the braking direction relative to the cylinder portion 13, the torsion spring 72 disposed between the torque transmission member 114 and the cylinder portion 13 is elastically deformed in the torsion direction and stores elastic energy therein.

On the other hand, at the time of braking release, the electric motor 32 rotates in the braking release direction according to an instruction from the control device, and, along therewith, the rotation thereof in the braking release direction is transmitted to the nut member 105 via the speed reduction gear mechanism 33. As a result, the push rod 106 threadedly engaged with the nut member 105 and the push plate 108 are retracted in the initial position direction according to the rotation of the nut member 105 in the braking release direction, by which the predetermined clearance is generated between the inner and outer brake pads 2 and 3, and the disk rotor D and the braking force is released.

At the time of this braking release, when the nut member 105 rotates in the braking release direction, the tightening force of the spring clutch 73 onto the nut member 105 reduces. As a result, the rotation of the nut member 105 in the braking release direction is not transmitted to the torque transmission member 114 via the spring clutch 73, but the torque transmission member 114 rotates in the braking release direction to return to the initial position due to the restoring force of the torsion spring 72 elastically deformed at the time of braking.

Further, if a failure occurs in the power source or the like and the electric motor 32 is not driven normally during braking, the torsion spring 72 elastically deformed at the time of the braking is restored, i.e., the elastic energy stored at the time of the braking is released. Then, the torque transmission member 114 rotates in the braking release direction due to the restoring force of the torsion spring 72. Then, because the tightening force exerted by the spring clutch 73 and directed toward the radial center of the nut member 105 is in a strong state, the nut member 105 rotates in the braking release direction to return to around the initial position according to the rotation of the torque transmission member 114 in the braking release direction (the return thereof to the initial position). As a result, the push rod 106 and the push plate 108 are retracted in the initial position direction, and the braking force applied by the inner and outer brake pads 2 and 3 to the disk rotor D reduces.

In the above-described disk brake 1C according to the third embodiment, especially, the push rod 106, the nut member 105, the spring clutch 73, and the torque transmission member 114 are disposed so as to overlap one another as viewed from the radial direction. As a result, the disk brake 1C according to the third embodiment can also achieve a reduction in the length thereof along the axial direction of the disk rotor D. Due to that, the disk brake 1C according to the third embodiment can also attain improved layout flexibility and excellent mountability onto a vehicle.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2021-206048 filed on Dec. 20, 2021. The entire disclosure of Japanese Patent Application No. 2021-206048 filed on Dec. 20, 2021 including the specification, the claims, the drawings, and the abstract is incorporated herein by reference in its entirety.

### REFERENCE SIGNS LIST

1A, 1B, 1C disk brake (electric brake apparatus)
2 inner brake pad (frictional pad)
3 outer brake pad (frictional pad)
9 drive unit
13 cylinder portion (fixation portion)
32 electric motor
34 rotation-linear motion conversion mechanism
35 fail-open mechanism
40 spindle (rotational member)
41 nut member (linear motion member)
45 annular support portion (outer peripheral flange portion)
48 annular groove portion
70 fixation member (fixation portion)
71 torque transmission member
72 torsion spring (elastic member)
73 spring clutch (torque limiter mechanism)
90 engagement slit portion (fitted portion)
100 truncated conical spring (elastic body or torque limiter mechanism)
102 inner peripheral flange portion
105 nut member (rotational member)
106 push rod (linear motion member)
114 torque transmission member
D disk rotor (disk)

1. An electric brake apparatus comprising:
an electric motor;
a rotational member configured to rotate based on driving of the electric motor;
a linear motion member configured to linearly move in an axial direction of a disk due to the rotation of the rotational member and move a frictional pad;
a torque transmission member;
a torque limiter mechanism disposed between the rotational member and the torque transmission member, the torque limiter mechanism being configured to cause the torque transmission member to rotate together with the rotational member until a rotational resistance force between the rotational member and the torque limiter mechanism exceeds a predetermined value;
a fixation portion; and
an elastic member having a one-end portion connected to the torque transmission member and an opposite-end portion connected to the fixation portion, the elastic member being configured to store elastic energy therein due to a rotation of the torque transmission member relative to the fixation portion according to the rotation of the rotational member.

2. The electric brake apparatus according to claim 1, wherein the elastic member
stores the elastic energy therein at the time of advancement to move the frictional pad in a direction for pressing it against the disk due to a forward rotation of the electric motor, and
provides a reversely directed torque to the rotational member by releasing the elastic energy at the time of retraction to move the frictional pad in a direction for separating it from the disk due to a reverse rotation of the electric motor.

3. The electric brake apparatus according to claim 1, wherein the elastic member is a torsion spring.

4. The electric brake apparatus according to claim 1, wherein the torque limiter mechanism and the linear motion member are disposed so as to overlap each other as viewed from a radial direction of the rotational member.

5. The electric brake apparatus according to claim 4, wherein the elastic member and the linear motion member are disposed so as to overlap each other as viewed from the radial direction of the rotational member.

6. The electric brake apparatus according to claim 1, wherein the torque limiter mechanism is a spring clutch wound around an annular groove portion provided on an outer peripheral portion of the rotational member, and
wherein a one-end portion of the spring clutch is fitted to a fitted portion provided on the torque transmission member.

7. The electric brake apparatus according to claim 6, wherein the spring clutch is wound in a state having a tightening force onto the annular groove portion when being mounted.

8. The electric brake apparatus according to claim 1, wherein the torque limiter mechanism is an elastic body disposed between an inner peripheral flange portion and an outer peripheral flange portion, the inner peripheral flange portion being provided in a manner protruding from an inner peripheral surface of the torque transmission member toward a radially inner side of the torque transmission member, the outer peripheral flange portion being provided in a manner protruding from an outer peripheral surface of the rotational member toward a radially outer side of the rotational member.

9. The electric brake apparatus according to claim 8, wherein the elastic body is set up in a state of applying a biasing force in a direction for separating the inner peripheral flange portion and the outer peripheral flange portion from each other when being mounted.

10. The electric brake apparatus according to claim 1, wherein the elastic member is set up in a state that a set load is applied thereto when being mounted.

11. The electric brake apparatus according to claim 1, wherein the rotational member is a spindle, and
wherein the linear motion member is a nut member threadedly engaged with the spindle.

12. The electric brake apparatus according to claim 1, wherein the rotational member is a nut member, and
wherein the linear motion member is a push rod threadedly engaged with the nut member.

13. An electric brake apparatus comprising:
an electric motor;
a rotational member coupled with the electric motor;
a linear motion member threadedly engaged with the rotational member;
a torque transmission member;
a torque limiter mechanism disposed between the rotational member and the torque transmission member, the torque limiter mechanism being configured to cause the torque transmission member to rotate together with the rotational member until a rotational resistance force between the rotational member and the torque limiter mechanism exceeds a predetermined value;
a fixation portion; and
a torsion spring having a one-end portion connected to the torque transmission member and an opposite-end portion connected to the fixation portion.

14. A drive unit configured to provide power for pressing a frictional pad against a disk of a disk brake, the drive unit comprising:
an electric motor;
a rotational member configured to rotate based on driving of the electric motor;
a linear motion member configured to linearly move due to the rotation of the rotational member;
a torque transmission member;
a torque limiter mechanism disposed between the rotational member and the torque transmission member, the torque limiter mechanism being configured to cause the torque transmission member to rotate together with the rotational member until a rotational resistance force between the rotational member and the torque limiter mechanism exceeds a predetermined value;
a fixation portion; and
an elastic member having a one-end portion connected to the torque transmission member and an opposite-end portion connected to the fixation portion, the elastic member being configured to store elastic energy therein due to a rotation of the torque transmission member relative to the fixation portion according to the rotation of the rotational member.

15. The electric brake apparatus according to claim 2, wherein the elastic member is a torsion spring.
